(19) United States
(12) Patent Application Publication
(10) Pub. No.: US 2014/0039879 A1
(43) Pub. Date: Feb. 6, 2014

(54) GENERIC SYSTEM FOR LINGUISTIC ANALYSIS AND TRANSFORMATION

(71) Applicant: Vadim Berman, Camberwell (AU)

(72) Inventor: Vadim Berman, Camberwell (AU)

(21) Appl. No.: 13/980,414

(22) PCT Filed: Apr. 27, 2011
(86) PCT No.: PCT/AU11/00483

§ 371 Date: Sep. 25, 2013

(51) Int. Cl. G06F 17/21

(52) U.S. Cl. CPC G06F 17/21
USPC 704/9

(57) ABSTRACT

A system providing a set of natural language processing functionalities, such as named entity extraction, domain extraction, sense disambiguation, automatic translation between different natural languages, morphological analysis, tokenization, via a unified process of analysis and transformation, using underlying linguistic database. The invention can accept text input and can be used to translate text, find out the correct sense of a word, obtain the main subject of a text, obtain the grammatical attributes of a word, paraphrase a text, and search for specific entities within the input text.

### BACKGROUND OF THE INVENTION

1. Technical Field

The present invention relates to the natural language analysis and transformation, and more specifically, to multifunctional natural language analysis and transformation systems using same linguistic data for all functions.

Said analysis and transformation is used for the following tasks:
Sense disambiguation
Named entity extraction
Domain extraction
Automatic translation (also known as machine translation or MT)
Paraphrasing
Morphological analysis
Cross-lingual search
Semantic search

This invention enables to reuse linguistic logic by “building once, use in many different applications”.

2. Background Art

While natural language processing was one of the most important areas of the computer science since the computers came into existence, the advance of natural language applications has been relatively slow. The biggest obstacle is the difficulty and prohibitive development cost of creation of new languages and linguistic components. As natural languages often lack consistency in their rules and vary greatly one from another, different modules are created to handle different languages. Natural language software today is largely expensive, inefficient, and not reusable.

For instance, some languages (like Chinese or Japanese) do not employ white spaces to delimit words, while other languages do. Some languages have a complex system of inflections, while other languages don't. All languages are ambiguous, with one word potentially having more than one meaning.

Conventional systems employ different techniques for different tasks, domains, and languages. For instance, different automatic translation modules handle languages without white spaces and those with spaces. Different modules and language models are typically used for semantic search and named entity extraction. Sometimes these techniques involve manually built rules, sometimes they involve machine-learning. While machine learning techniques may reduce the development cycle, they do not eliminate the main issues, such as reusability and maintainability. The necessity to build different models of the same languages over and over reduces the return on investment of the language models and applications as components. As these components have a relatively short life cycle, the incentive to invest in quality and features is low.

On one hand, under these constraints the software must be generic enough to be used in as many scenarios as possible; on the other hand, as language may have local lingo or special terms, it has to be adapted to these local scenarios. Therefore, the ability to customize the software to particular scenarios is a highly-prized feature, yet again, with relatively short life cycle, the investment in this aspect is limited.

Consequently, natural language software today is largely expensive, inefficient, and difficult to reuse.

### CITATION LIST

### Patent Documents

U.S. Pat. No. 5,148,541 Lee, D'Cruz, Kulinek 9/1992

U.S. Pat. No. 5,173,853 Kelly, McNelis, Smith 12/1992

U.S. Pat. No. 5,587,902 Kugimiya 12/1996

U.S. Pat. No. 5,682,543 Shiomi 10/1997

U.S. Pat. No. 5,870,751 Trotter 2/1999

U.S. Pat. No. 6,263,329 Evans 7/2001

U.S. Pat. No. 7,013,261 Eisele 3/2006

U.S. Pat. No. 7,146,383 Margin, Chang, Ying 12/2006

DISCLOSURE OF INVENTION

### Technical Problem

The challenges in natural language engineering, that this invention is addressing, are:
scaling the language support of existing linguistic databases to new languages and domains of discourse
reusability of the existing linguistic databases
poor customisation capabilities
creating multimodal applications, which refer to the same linguistic database, such as crosslingual retrieval applications coupled with automatic translation, or semantic search systems merged with question answering systems

### Technical Solution

It is therefore an object of the present invention to provide a reusable system which uses accumulated linguistic knowledge for a plurality of natural language applications, in order to preserve the effort in building different linguistic databases for these different applications and domains.

Another object of the present invention is to provide a reusable system which uses the same linguistic database for the following applications:
Sense disambiguation
Named entity extraction
Domain extraction
Automatic translation (also known as machine translation or MT)
Paraphrasing
Morphological analysis
Cross-lingual search
Semantic search

This is achieved by providing a uniform analysis process, which produces an unambiguous language-neutral representation of the input content, the results of which are used in the aforementioned applications.

Yet another object of the present invention is to provide a system in which all the aspects are customisable. Therefore, the system stores all the linguistic information in use, in a relational database. The customisation achieved by simply altering the data tables.

### DESCRIPTION OF DRAWINGS

FIG. 1 is a diagram showing the overview of the architecture of the system;

FIG. 2 is a diagram showing the overview of the database structure;

FIG. 3 is a diagram showing the data structure of the lexical dictionary entries;

FIG. 4 is an illustration of a sample screen editing a linguistic entity;

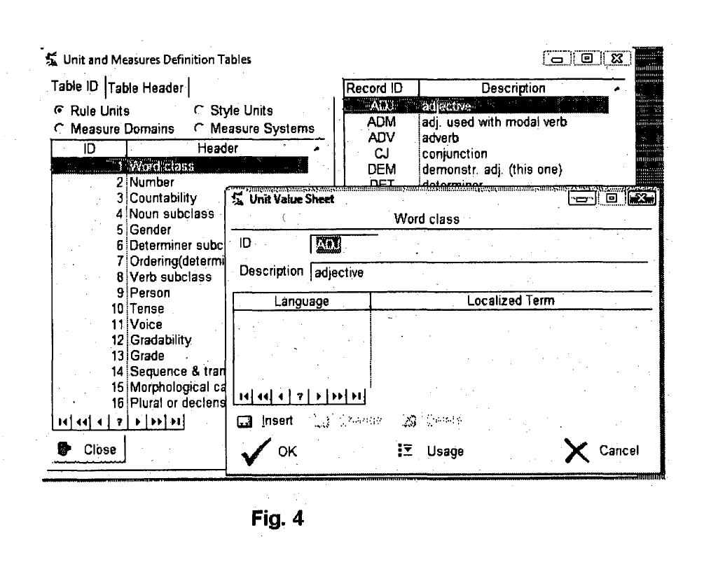

FIG. 5 is a flow chart showing the operation sequence in the system;

FIG. 6 is a flow chart showing the operation sequence in the shallow tokenisation stage;

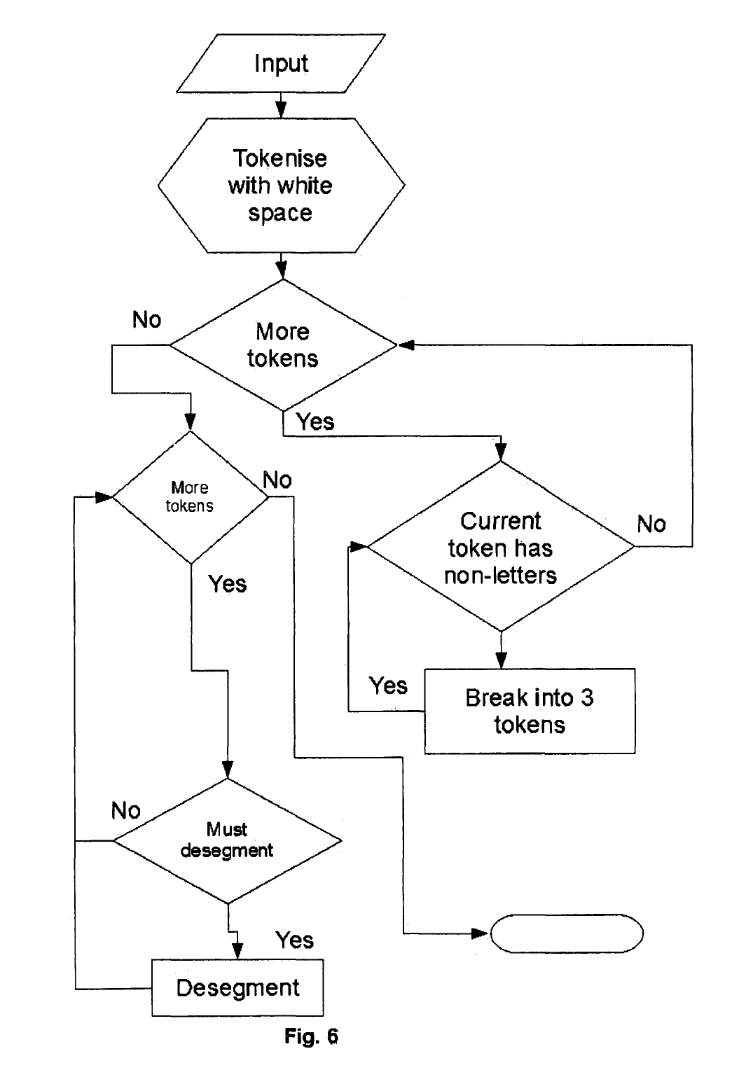

FIG. 7 is a flow chart showing the operation sequence in the guess creation stage;

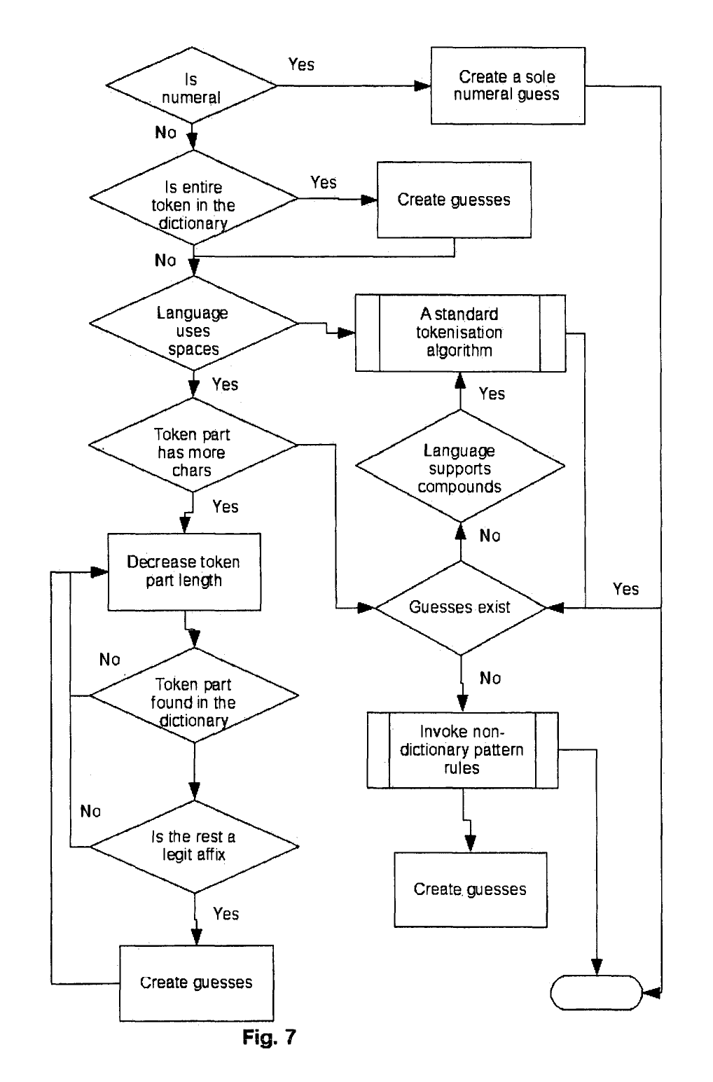

FIG. 8 is a flow chart showing the operation sequence in the disambiguation stage;

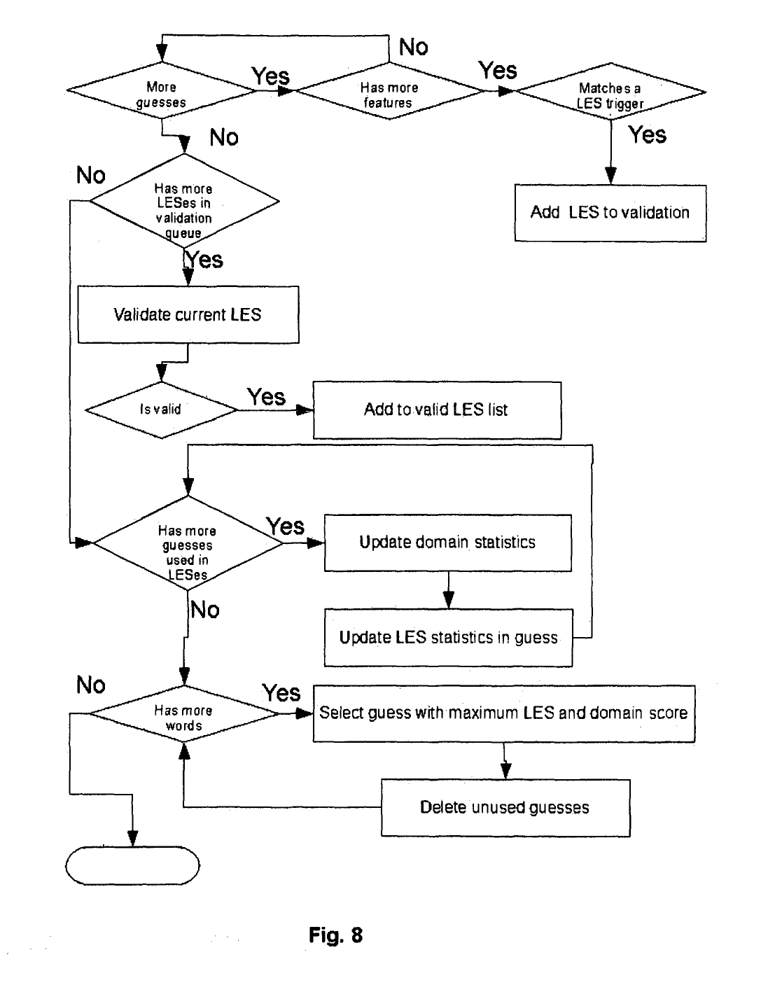

FIG. 9 is a flow chart showing the operation sequence in the transformation stage;

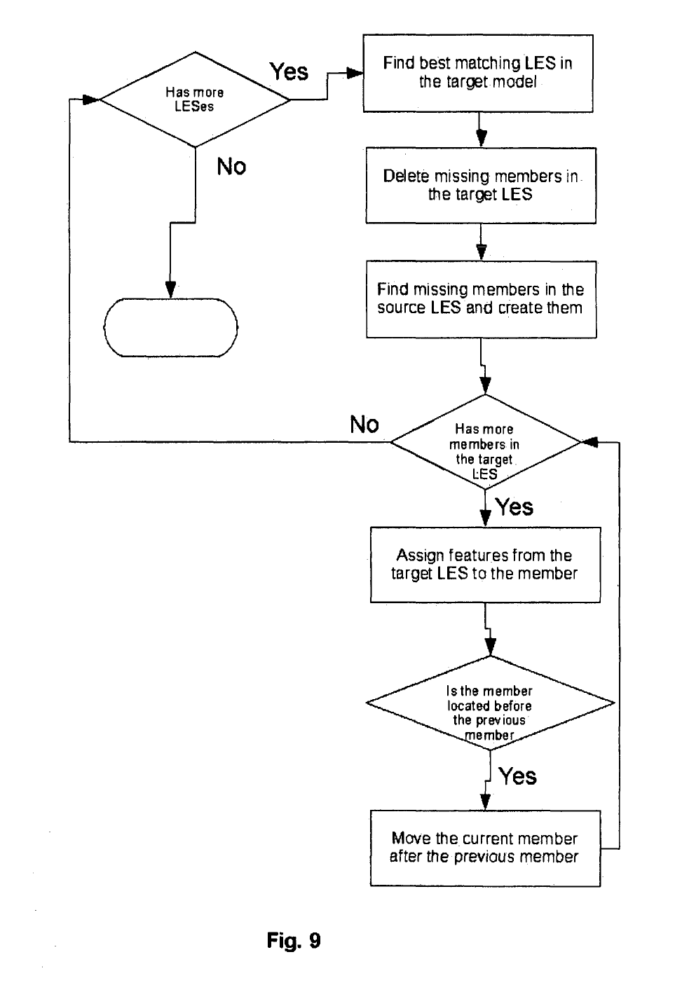

FIG. 10 is a flow chart showing the operation sequence in the generation stage;

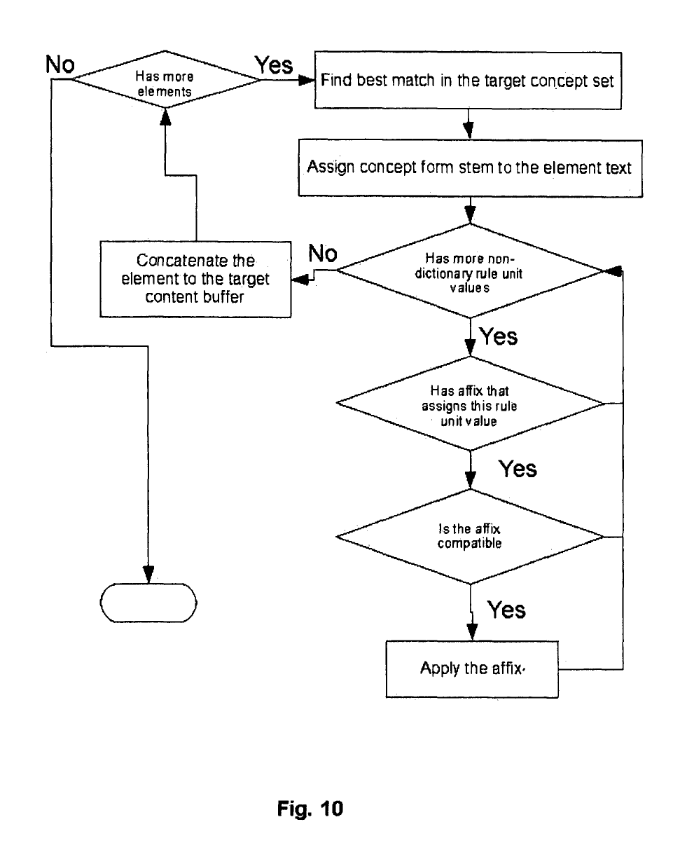

### INDUSTRIAL APPLICABILITY 191 The invention has industrial applicability in the area of software development.

### DESCRIPTION OF EMBODIMENTS

### Detailed Description Of The Preferred Embodiment

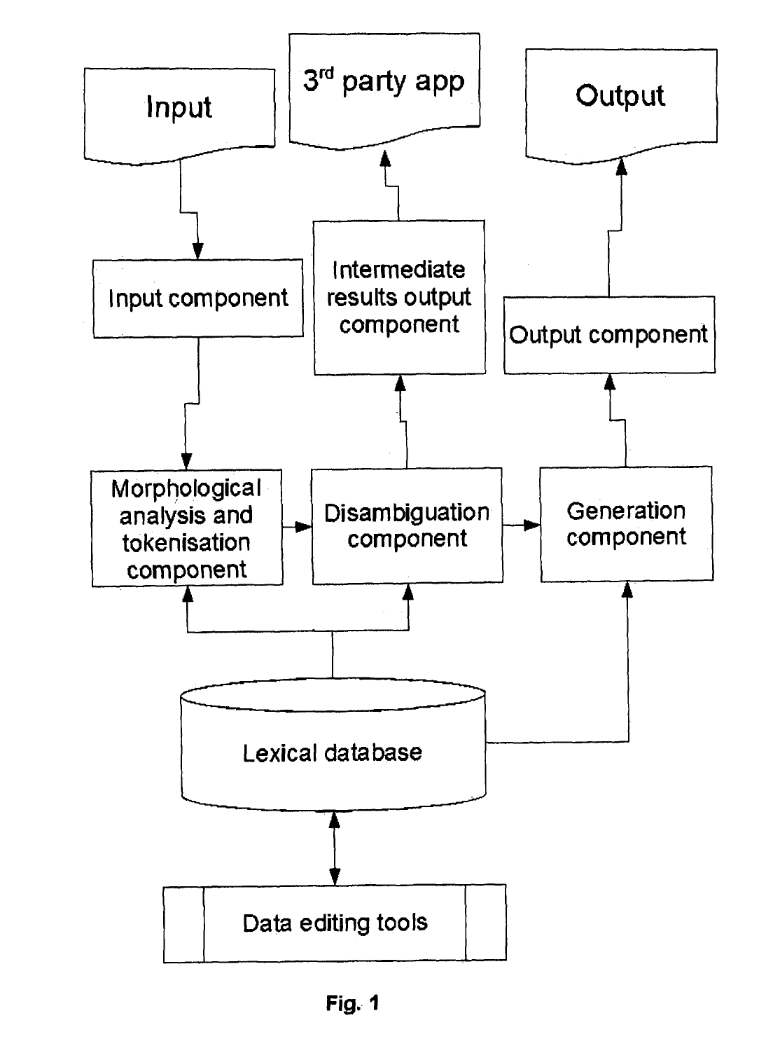

151 As shown on FIG. 1, the linguistic database is in the core of the present invention. Various components obtain data from the linguistic database and use it for all the system purposes, as described in section APPLICATIONS.

As shown on FIG. 1, the linguistic database is in the core of the present invention.

Various components obtain data from the linguistic database and use it for all the system purposes, as described in section APPLICATIONS.

### A. Database Entities

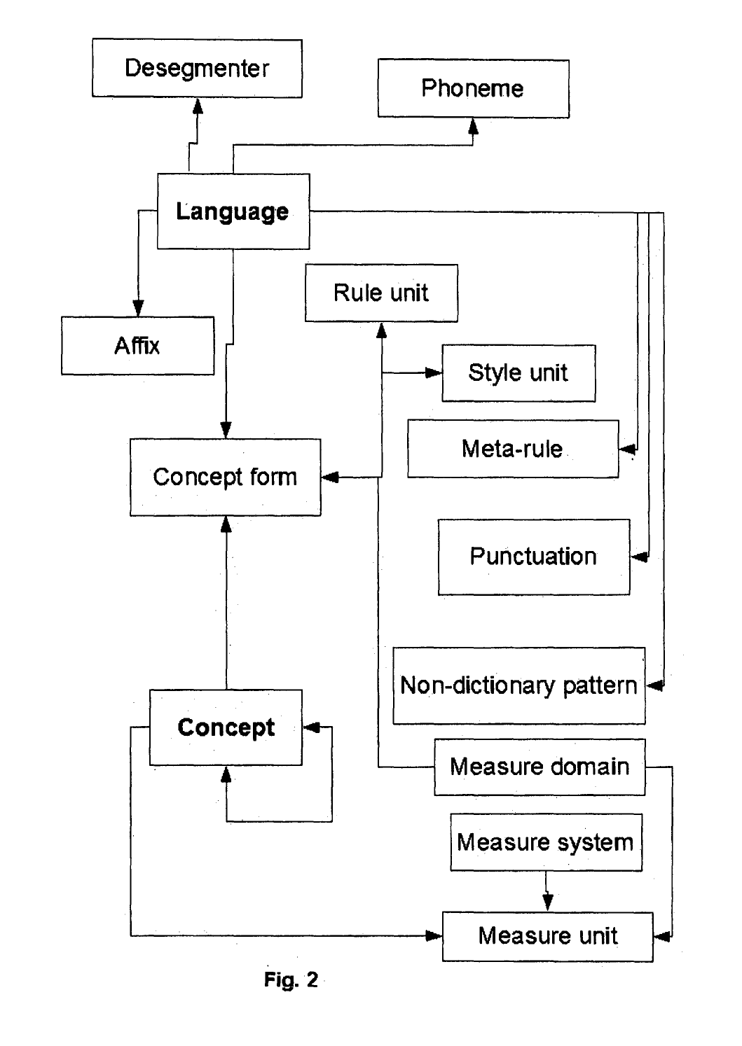

This chapter explains the attributes and the entities in the database, as shown on FIG. 2. The way they are used is explained in the next chapters.

The main two entities in the database are language and concept .

A language contains the basic information regarding the natural language:
Internal code (can be a string or a number)
Name
Character set (if the system is not using Unicode)
Segmentation mode, with the following values:
   None
   Analysis of compound words (suitable for languages like German or
   Dutch)
   No space (suitable for languages like Chinese, Japanese, Thai)

A concept models a concept expressed by a natural language utterance, such as an entity, an action, an attribute, a modifier such as an adjective or an adverb. Concepts are not linked to a specific language, or style. Concepts reflect the real world beyond linguistics, and together form a semantic network. A concept has the following attributes:
An internal numeric code (ID)
Links to other concepts. There are two links used in the semantic network of concepts:
   Super-type/subtype link, where the subtype concept is a more specific kind of the super-type concept, such as hypernym/hyponym, or hypernym/troponym. For instance, the concept “car” is a subtype of the concept “vehicle”.
   Domain/domain member link, where the domain member concept is normally a part of a specific domain of discourse expressed by the domain concept. Unlike the super-type/subtype link, the domain links may be defined in a plurality of ways, depending on the target use of the system. For instance, the concept “car” may be a domain member of the domain concept “driving”, or a domain concept “mechanical device”.

A rule unit is a piece of grammatical or semantic information, such as part of speech, morphological case, number, gender, or tense. Rule units have the following attributes:
A rule unit category code. A category specifies the kind of the rule unit, e.g.
part of speech, gender, tense, animacy, or anything else.

A rule unit value

A style unit stores stylistic information, such as the medium where it's used, regional usage, or sentiment. Like the rule unit, a style unit has a category code and a value. Optionally, both the rule units and the style units may have descriptions for the convenience of data designers.

An affix is a prefix, a suffix, or an infix applied on a stem to obtain inflected forms or a lemma. An affix has the following attributes:
Affix string which is concatenated to the stemmed form
Rule unit criteria to be met in order for the affix to be compatible with the word
Granted rule units applied on the target word if the affix is compatible
Style units applied on the target word
Phonetic compatibility criteria that must be met in order to be compatible with the adjacent pieces of the word
Relative position of the affix in case more than one affix is applied. Subsequently applied affixes must have a relative position higher than the last applied affix.

A meta-rule is a piece of linguistic logic, governing the way the system works with a language. There are several types of meta-rules. The attributes depend on the meta-rule type:
An agreement meta-rule is used to enforce an agreement in a governing and a governed word, depending on a source and a target rule unit. For instance, this is how the system is instructed that a noun must agree with a verb in number.

The attributes are:
Source rule unit category
Source rule unit value
Target rule unit category
Target rule unit value
A rule unit requirement meta-rule determines what rule units must be present in a word, depending on a presence of a rule unit. For instance, a word where the part of speech is noun must have a number (singular or plural).
A dictionary form meta-rule defines affixes used to obtain a stemmed form from a lemma.

A punctuation entity stores information about dots, commas, and other punctuation. Punctuation has the following attributes:
punctuation code, identical for equivalent punctuation in different languages.
A string containing the punctuation itself.

The desegmenter entity is used for initial shallow tokenisation. A desegmenter has the following attributes:
A trigger regular expression to validate the token
An adjacent segments regular expression

In order to implement functionality described in the claim 6, the PHONEME entity is used. Phonemes are grouped by language. A phoneme has the following attributes:
A phoneme code, identical for equivalent strings in different languages. For instance, a phoneme “sh” will have the same phoneme code in all languages, regardless of the language script.
A string in the language script expressing the phoneme
A location constraint of the phoneme usage, such as “end only”, “beginning only”, “middle only”.

In order to implement functionality described in the claim 8, measure domain, measure system and measure unit entities exist. A measure system is simply a code signifying a system of measures, e.g. English, imperial, metric, or other. A measure domain is also a code meaning what is being measured, e.g. weight, length, temperature. A measure unit has the following attributes, in addition to the links to measure domain and measure system:
a code of the relevant concept(such as yard, metre, kilogram, ounce, or other)
a value in base units, which is a floating point number, containing the number of base units in this measure domain. A base unit is a measure unit taken as a base. For instance, we can say that in the measures of weight, we'll take a kilogram as a base. In this case, a pound will be 0.454 base units, and a gram will be 0.001 base units.

A concept form is a word or a language entity sequence related to a concept in a specific language, with a specified set of rule units and style units. A concept form represents a natural language utterance for a concept in a specific language in a specific style. It is an equivalent of a dictionary or a glossary or a thesaurus record in a traditional paper compiled lexicographical work. A concept form has the following attributes:
A stem, which is a basic uninflected form. If the concept form is a language entity sequence, the stem attribute may contain an encoded representation of a language entity sequence described in the claim 3.
A lemma, which is a dictionary form of a word. If the concept form is a group of words, the lemma attribute bears no significance, but may hold a user-friendly description of the concept form.
Style tags
For the functionality described in the claim 8, if the concept form is a group of words, a measure domain code may be specified.
Two arrays of rule units, each comprised of a rule unit category and a rule unit value:
   Language-independent rule units, which are assumed to be the equivalent across different languages in the same database
   Language-derived rule units, which may vary among different languages

In order to implement functionality described in the claim 4, the entity non-dictionary pattern is used. The entity contains the following attributes:
A processing priority value
A validation regular expression to validate the pattern
A super-type of the pattern in the semantic network of concepts. For example, an actual email address will have a super-type “email address”, a last name will have a super-type “last name”, and so on.
Rule units assigned to the pattern
Style units assigned to the pattern
An optional formula to calculate a numeric value (for example, for a formatted currency value like $123,456.78)
A flag whether the pattern should be kept in its original script when translating. If the flag is off, the pattern is to be transliterated to the target script. This is suitable for patterns like last names. On the other hand, the email addresses and URLs shouldn't be transliterated.

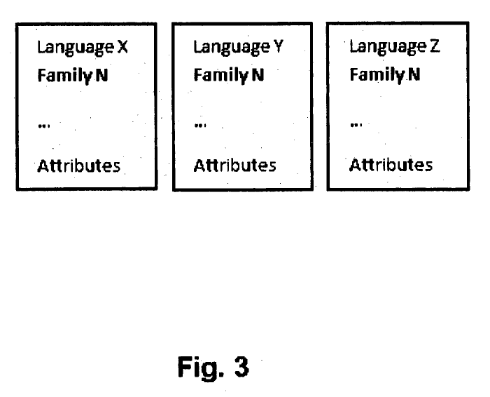

The data entities are accessible via data editing tools, such as the one shown on FIG. 3.

### B. Process Flow

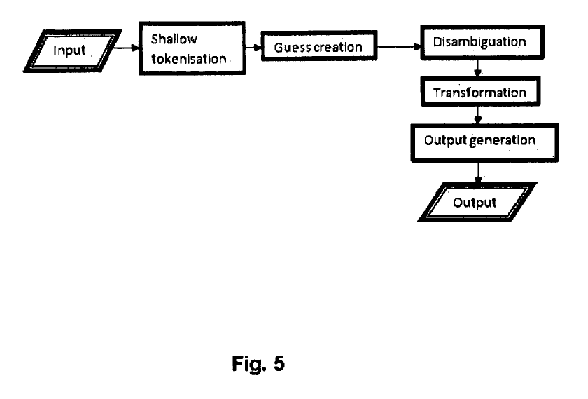

The top level process flow is shown on FIG. 5. The processing consists of the following stages:
1. Shallow tokenisation: the textual input is split into tokens by locating white spaces, line breaks, numerals, and punctuation.
2. Guess creation: the tokens are inspected against the dictionary, and possible guesses are created:
   a. For languages with segmentation mode attribute set to “none”, it is assumed that the token only contains one word.
   b. For languages with segmentation mode attribute set to “compound analysis”, if no suitable words found, the system searches for a combination of several words of which the token consists.
   c. For languages with segmentation mode attribute set to “no space”, the token is segmented into several words.
3. Disambiguation: dominant domains and context is analysed, and the guesses are given confidence scores. For every word, a guess with the highest confidence score is assumed to be correct. Language entity sequences as described in the claim 3 are mapped.
4. Transformation: equivalent target language entity sequences as described in the claim 3 is compared with the source sequences mapped in the previous stage, and the different attributes are assigned to the members of each sequence.
5. Generation: a text in the target language is generated.

### B1. Language Entity Sequence (Les) Mini-Language

The language entity sequences are ordered groups of natural language entities (words, punctuation marks) with specific attributes. They can be thought as an equivalent of regular expressions for natural language. The main difference between the two, however, is while regular expressions are deterministic and match known entities (characters), the language entity sequences are essentially hypotheses, and even if positively matched, might be removed, if they do not fit in the general trend. Normally language entity sequences capture logically linked elements.

The language entity sequences are used for:
Capturing natural language patterns, such as idioms, syntactic structures (adjective +noun), special multi-word entities (given name +surname)
Handling structural differences between the source and the target (e.g.

converting French “il y a”+noun to English “there is” +noun)

Every LES contains:
One or more members with a numbered identity, described by a group of one or more attributes. One of these members is designated a triggering element, with a feature that triggers the sequence validation. Once an element in the content being processed satisfies this set of conditions, sequence is added to the validation queue as described in Disambiguation chapter. It is recommended to specify the element with the most features as the triggering element.
Optional constraints on the allowed language entities in the vicinity of the LES members, which serve to validate the LES hypothesis. For instance, if we are looking for a combination verb+noun in English, and a word is ambiguous enough to be a verb or a noun, then finding a definite article in front of it strengthens the assumption that it is a noun rather than a verb. The constraints are also described by a group of one or more attributes.
So-called “validation points” value, used for disambiguation as described in Disambiguation chapter.
Optional reference to a measure domain in order to implement the functionality in claim 8.

### B1.1 Suggested Implementation

The LES description language must be brief to keep the expressions portable, facilitating easy exchange between LES writers. A suggested implementation is described below.

The LES members are delimited by % (percent) character. The attributes within the member are delimited by $ (dollar) character. Attributes and their values are delimited by “=” (equality) character. A LES may look like this:

C=345$O=1$I=1%R1=VERB$@$G=1$I=2%

The following attributes are supported:
R—rule unit. Must have an index, and a value. For example, R1=VERB means that the value of the rule unit 1 is VERB.
S—style unit. Must have an index, and a value. For example, S1=TALK means that the value of the style unit 1 is TALK.
C—word concept ID. Example: C=10394 means that the word belongs to the family 10394.
H—a family ID of a hypernym. Example: H=10394 means that the word must have a hypernym link to the family 10394.
P—a punctuation mark. If there is no value, the element can be any punctuation mark (but not a numeral or a token). Otherwise, the value is a punctuation mark ID.
O—an order category. Valid values are:
   1—a first member in a sentence
   L—a last member in a sentence
   M—a member in a sentence which is neither a first nor a last one (middle)

N—a numeral. If there is no value, the element can be any numeral (but not a token or a punctuation mark).Otherwise, the value must be either a number (without commas and other formatting characters, floating point is supported) or a formula which must evaluate as true.
T—a case of the element. Supported values:
   L—lower
   C—capitalized
   U—upper
   A—all cases
X—a regular expression to validate.
@—indicates that the member is a clitic word must be attached to another token. No values.
I—identity of a member. The identity must be unique within the current sequence.
G—governing priority of a member used to enforce grammatical agreement.

At least one member with priority 1 must exist in a sequence.
˜—marks a possible (but not necessary) gap between two members. Anything can fit within this gap, unless gap constraints (see next items) are specified.

The length of the gap may be limited by the following attributes:
>—minimum length
<—maximum length
!—marks negative constraints, that is, members and attributes which must not validate as true. If the character is the first property of a member, the entire member is a negative constraint; otherwise, only the following attribute is a negative constraint. Negative constraint members are not required to have an identity. If the inverse member directly follows/precedes a regular member, only the element following/preceding the one mapped to that regular member is checked. If there is a possible gap between the two, all the elements in a gap are checked.
*—marks positive constraints. If a positive constraint is specified next to a sequence member, this means that the adjacent elements must satisfy these constraints in order for the sequence to be validated as true.
#—marks “fail if” conditions. If the condition following this flag, is evaluated as true in any of the guesses, the entire element is held invalid.

### B2. Shallow Tokenisation

The purpose of the shallow tokenisation stage is to divide the flow of text into words, or segments in case of languages that do not use white spaces. This process receives an unstructured text as input, and returns a list of tokens as output. The steps are as follows:
1. The text is tokenized using white space as a delimiter. (This applies also to languages which do not rely on white spaces to delimit words, as these languages, too, apply spaces in certain circumstances.)
2. Every token is inspected for the presence of:
   Punctuation marks
      Numerals
3. The tokens are further divided into portions which are numeral, punctuation, and letters. This is easiest to accomplish using regular expressions referring to character classes, or lists of characters belonging to each class.
4. Once divided, the tokens are matched against a list of “desegmenter” regular expressions: certain adjacent tokens must be put together, for instance, decimal numbers, URLs, and other entities which contain a mix of different classes (numerals, punctuation, and letters).

### B3. Guess Creation

The purpose of this stage is to match the tokens, created by shallow tokenisation, against the dictionary, creating a list of possible interpretations for every token, or “guesses”. The process receives a set of tokens as input, and returns a set of guesses as output. The steps are as following for every token:
1. Check if the token is a numeral. If yes, mark as such, create a sole guess which interprets the token as a numeral, and move to the next stage.
2. Try fetching the entire token in the dictionary. If successful, load all the interpretations of the token as guesses.
3. Try to find a combination of words and compatible affixes, which together form the argument token. This is done by different ways, depending on whether the language uses white spaces:
   For languages that use white spaces:
      i. Match the starting and the ending part of the token with concept forms in the database, where the piece being matched is compared with stems of the concept form in the database. The maximum and minimum length of the starting and ending parts to be matched are defined in the current language's parameters.
      ii. For each matching concept form, match the starting and the ending parts of the token with the affixes stored in the database. Verify that the required rule units are present in the concept form and the granted rule units do not contradict the rule units in the concept form. If the checks were passed, add the configuration of matching concept form and the affixes as a guess.
   For languages that do not use white spaces, we assume that there are no affixes. (While some linguists might argue that, for instance, Japanese has affixes which indicate verb inflections, these can be viewed as particles constituting separate “words”.) Any available standard text segmentation algorithm can be used here, such as maximum tokenisation, backward maximum tokenisation, or any other algorithm dividing the text flow into words. All the interpretations of the detected segments are added as detected guesses.
4. If no guesses were created, and the language may have compounds (such as German or Dutch), a standard segmentation algorithm is applied to the token, which is treated as text in a language not using spaces, as described above.
5. If still no guesses were created, a set of rules describing non-dictionary patterns is applied. The non-dictionary patterns are processed in the order of processing priority. If the regular expression in a non-dictionary pattern is matched, the token is assigned the rule units of the non-dictionary pattern, and the hypernym of the non-dictionary pattern, and a guess is created using these attributes. This allows the entities not present in the dictionary(such as email addresses, phone numbers, or simply unspecified proper names) to become integral parts of the sentence, without disrupting the connections between the sentence elements.

### B4. Disambiguation

The purpose of this stage is to narrow down the guesses to one interpretation per word. During the disambiguation stage, language entity sequences (LES) are matched to the guesses, and prevailing domains are determined. The steps are as following:
1. Building the LES validation queue:
   a. For every feature in every guess, check whether it is listed among the triggering features of the triggering elements.
   b. If yes, validate the entire guess against the condition set of the triggering element.
   c. If there is a match, add the entire language entity sequence to the validation queue. Determine the minimum start parameter of the validation by subtracting the maximum distance between the start of the LES and the triggering element.
2. LES validation:
   a. For every LES in the validation queue, starting with the element at the minimum start position determined in 1c, validate all the members of the LES. If none of the guesses of an element satisfies the constraints, the language entity sequence is invalid.
   b. Add positively validated language entity sequences to the validated LES queue, and update the guesses satisfying the constraints of the LES, adding the sequence's validation points to the guess' validation points.
3. Once all the language entity sequences are validated, count the domains referred by the guesses—only in those guesses which are linked to positively validated language entity sequences. If no language entity sequences are valid, count the domain for all guesses.
4. Calculate domain actuality points. For those domains with the count below the threshold in the current sentence (threshold is a constant normally set to 2), set the domain actuality points to 0. Otherwise, use the formula: [Weight of the global domain value]*[global domain occurrences]+[Weight of the local domain value]*([local domain occurrences]−1).
5. Obtain the total point count for every guess, adding the validation points and the domain actuality points, adjusted by optional weight of either of the factors. The weights can be set on the system level, or on the language level. Normally, the ratio is about 50 for the validation points to 3 for domain actuality points.
6. Select the guesses with the maximum total point count per element. Count the most frequent domains, and store them into the global domain value array.
7. Delete all the other guesses. Delete all the language entity sequences pointing to the deleted guesses.

At the end of this stage, the system possesses a language-neutral representation of the source text, having grammatical information (rule units), stylistic information (style units), and references to the semantic network (concept IDs). Said representation may be consumed by 3rd party applications, using an output component.

### B5. Transformation

This stage only exists for applications which require transformation, such as automatic translation or paraphrasing. Applications using the system for analysis stop at the disambiguation stage.

The purpose of the transformation stage is to manipulate elements in order to adjust the sentence to the target model. This is achieved by comparing the equivalent linguistic entity sequences in the source and the target models. For instance, if the LES in the source language is <noun> <adjective>, and the LES of the same concept ID in the target language <adjective> <noun>, the system moves the first element after the second. The equivalence of members is determined by the identity attribute assigned to every member of the sequence.

The steps are as following for every LES:
1. Determine a target LES by finding the sequence in the target model with the highest number of rule units and style units equal in value in the source LES.
2. Determine the members to be deleted by looking up the members from the source LES that do not exist in the target LES. Delete these elements.
3. Determine the members to be inserted by looking up the members from the target LES that do not exist in the source LES. Create new elements, and assign the attributes from the target LES member specifications.
4. Going from first to last, for every member in the target LES, compare its position with the previous member of the target LES. If the current member is before the previous member, move it to the position immediately after that previous member. Assign the attributes from the target LES.
5. If the LES contains a measure domain, it is assumed to have a numeric value and a measure unit belonging to the specified measure domain. If the system is configured to prefer a different measure system than the one of one or more of the measure units associated with the concepts of the LES members, the following steps are taken:
   a. A total value in base units of the LES measure domain is calculated by multiplying the basic unit value for every measure unit in the LES by an adjacent value, and summing up all the resulted values.
   b. For each of the measure units in the target measure system, starting with the greatest one down to the smallest one, the total value is divided into the number of basic units in the measure unit. A new target LES is created, which is built of pairs of concept ID numbers and the numerical values, resulted by the division. The last remainder is assigned to the smallest measure unit.

Once done with all the transformations, for every LES, enforce agreement in the rule units based on the governing priority parameters inside LES: the members with lower governing priorities must copy rule units from those with higher governing priorities. It is important to execute this step only after all the transformations are done, as some elements may be inserted or deleted in the process, and the governing priorities may change.

### B6. GENERATION

At this stage, the abstract language-neutral structures are converted into actual text, based on their attributes and the target language data.

The steps are as follows:
1. For every element, look for a concept form record as specified by the concept ID of the element, where the language-independent rule units array best matches the rule units of the element, and style units best match the style units of the element. If the preferences are set to prefer a specific style, or to avoid a specific style, these preferences may override the style unit match. For example, the system may be configured to avoid colloquial terms in favour of the more formal terms. If not found, the element is left as is.
   a. If found:
      i. Assign the dictionary concept form stem to the element text.
      ii. Compare the rule units of the concept form with the rule units of the element. Prepare the list of rule units with a value different from that in the dictionary concept form.
         1. For every rule unit with a value different from that in the dictionary concept form, look for an affix which grants this rule unit value.
         2. Check that the rule unit criteria in the affix and the phonetic compatibility criteria are fulfilled.
         3. If no incompatibilities have been found, apply the affix by modifying the element's rule units and element text.
         4. If incompatible, look for another affix.
2. Concatenate all the elements into a target sentence, adding spaces, if the language supports spaces.
3. An output component exposes the target content to the caller.

### B7. Applications

This section describes how the various applications work with the system:
Sense disambiguation: simply obtain the concept IDs (references to the semantic network) from the intermediate results output component.
Named entity extraction: obtain the concept IDs (references to the semantic network) from the intermediate results output component, then look for those IDs which match the named entities you are looking for.
Domain extraction: obtain the concept IDs of the global domain value array produced in the disambiguation stage.
Automatic translation: set the source language and the target languages parameters, and obtain the output.
Paraphrasing: set the source language and the target languages to the same value, set the avoided or preferred styles, and obtain the output.
Morphological analysis: obtain the rule units from the intermediate results output component.
Cross-lingual search: on the indexing stage, obtain the concept IDs (references to the semantic network) from the intermediate results output component for the content to be searched, store them in the database. Upon receiving search request, process the search query, and present the user with various concept interpretations. Use the ID of the concept selected by the user to search the collection of concept IDs stored in the database on the indexing stage.
Semantic search: same as in cross-lingual search, but the query and the content language is the same.

1. A system for analysis and transformation of text content, made of:
a. a multilingual linguistic database, including lexicons and a semantic network;
b. an input component for receiving a processing request in a source language;
c. a morphological analysis and tokenisation component, building a list of interpretations according to the linguistic database;
d. a disambiguation component, analysing relationships between possible interpretations of the words and domains of discourse, said component yielding concept entries with grammatical, stylistic information, and references to the underlying semantic network;
e. a generation component, producing words out of language-neutral representation of the concept entries produced by the disambiguation component;
f. an intermediate results output component, producing language-neutral representation of the concept entries produced by the disambiguation component;
g. an output component, producing the transformed result, such as in a process of translation to a target language, paraphrasing, or style manipulation, based on the dictionary.

2. The system of claim 1 wherein said database contains all the linguistic logic, including definitions of the basic linguistic entities, like parts of speech, gender, number, including parsing rules, lexicon, and syntactic context.

3. The system of claim 1 wherein said disambiguation component uses a mini-language describing language entity sequences in order to disambiguate the interpretations, and transform content to the target state, such as in translation to another language, or paraphrasing.

4. The system of claim 1 wherein said dictionary contains recognition definitions for non-dictionary words and entities, such as email addresses, URLs, proper names allowing recognition of entities not defined in the underlying lexicons.

5. The system of claim 1 wherein said morphological and tokenisation component uses a tokenisation algorithm to tokenise input in language that do not use spaces.

6. The system of claim 1 wehre the unrecognised elements can be transliterated to the target language, if the scripts of the source language and the target language are different.

7. The system of claim 1 where the stylistic information can be altered to generate output with different style. For instance, a formal content in French can be translated into an informal content in English.

8. The system of claim 1 wherein the dictionary contains measures and metrics, which are used to convert the numeric data inline according to the user's preferences.
